(19) United States
(12) Patent Application Publication
(10) Pub. No.: US 2009/0302132 A1
(43) Pub. Date: Dec. 10, 2009

(54) SPRAY ENVELOPMENT SYSTEM

(76) Inventor: Thomas M. HARTLEY, Warsaw, OH (US)

Correspondence Address: GALLAGHER & DAWSEY CO., L.P.A., P.O. BOX 785, COLUMBUS, OH, 43216, US

(21) Appl. No.: 12/336,574

(22) Filed: Dec. 17, 2008

Related U.S. Application Data
(63) Continuation-in-part of application No. 12/135,457, filed on Jun. 9, 2008.

(51) Int. Cl. B05B 15/00

(52) U.S. Cl. 239/289

(57) ABSTRACT

A spray envelopment system including at least one pressurizable fluid reservoir containing a reservoir fluid which may be an anti-mold or anti-fungal agent is provided. The pressurizable fluid reservoir is in intermittent fluid communication with at least one fluid conduit and with a fluid controller. A plurality of spray heads and the at least one fluid conduit may further form an array extending over various parts of at least one of the external surfaces of a structure and may provide simultaneous spray coverage to a portion, and in some embodiments, a majority of a surface area of the plurality of external surfaces, including a roof. The fluid controller may include a timer and a remotely operable internet accessible controller. The pressurizable fluid reservoir may be in intermittent fluid communication with a building water supply, which can supply diluent for reservoir fluid and supply pressure to the system.

### CROSS-REFERENCE TO RELATED APPLICATIONS

This application is a continuation-in-part of a previous application filed in the United States Patent and Trademark Office on Jun. 9, 2008, titled “Three-Dimensional Spray Envelopment System,” and given Ser. No. 12/135,457, all of which is incorporated herein by reference as if completely written herein.

### TECHNICAL FIELD

The instant invention relates to a spray envelopment system, particularly to a system for simultaneously spraying at least one exterior surface of a structure.

### BACKGROUND OF THE INVENTION

Mold and mildew on the outside of structures, often homes, can be a vexing problem, particularly in warm and humid climate areas. Mold on the exterior of a structure is often in the form of mildew or green moss. Since moss is a form of mold, moss formation can deteriorate the outside of a home, particularly damaging exterior paint, and even when not physically damaging the structure, can be very unsightly. Mold growth can also lead to allergic reactions in those persons exposed, and many individuals are particularly susceptible to mold allergies.

Mold can also grow on the roofs, including shingle roofs, and can grow within roof gutters, particularly if the gutters frequently have standing water in them. On such roofs and gutters, mold growth can be extensive before it is noticed from the ground.

A traditional approach has included such environmental remediations as attempts to decrease the surface moisture level of the exterior walls of a structure by keeping vegetation back from the walls and decreasing lawn sprinkling overspray on exterior walls. However, again especially in warm and humid areas, this is frequently insufficient to prevent the growth of exterior mold.

Molds may be removed from the exterior of structures, often by power washing. This optimally requires either a professional contractor, or the purchase or rental of a potentially dangerous piece of equipment by an operator who may be unskilled in its safe use. The walls may be washed with a fungicide to remove the molds. In addition to the dangers facing the operator of a power washer, problems attendant to this method include the difficulty of washing above the first floor level, difficulty in washing relatively flat or angled surfaces such as roofs, difficulties in washing downwards into gutters that may be many feet in the air, and potential damage to the structure from high pressure washing. In particular, power washing can be highly damaging to painted and wood surfaces, often driving moisture into wood surfaces, which, in the long run, can worsen mold problems. Additionally, the procedure must be repeated periodically, and each time all the disadvantages and dangers noted above must be faced.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

A spray envelopment system may include at least one pressurizable fluid reservoir containing a reservoir fluid which may be an anti-mold or anti-fungal agent. The pressurizable fluid reservoir is connected to at least one fluid conduit and with a fluid controller, which controls the intermittent fluid communication of the pressurizable fluid reservoir and the fluid conduit.

Pressure may be generated within the pressurizable fluid reservoir in the form of a positive pressure created by a pump, fluid ingress, or other force, or may be created as a negative pressure by the withdrawal of contents from the pressurizable fluid reservoir. In its simplest embodiment, the fluid controller may be a hand controlled valve; or in more complex embodiments, may include a wide variety of automatically controlled and monitored valve systems.

The spray envelopment system also includes a plurality of spray heads having at least one spray pattern in fluid communication with the at least one fluid conduit. The spray heads and fluid conduit may further form an array extending over various parts of at least one external surface, or in some embodiments, multiple external surfaces of a structure and may provide simultaneous spray coverage to at least a portion, or in some embodiments a majority, of a surface area of the plurality of structure external surfaces. In some embodiments, spray coverage may be extended to the roof of a structure and it may be advantageous to place spray heads along a roof line, along roof gable ends, and along roof gutters.

The fluid controller may further include a timer and may further include a remotely operable internet accessible controller. The latter could allow long-distance control of the system; and any of the previously discussed embodiments may be configured for regular and periodic activation of the system, in at least some embodiments, without direct manual activation.

In a preferred embodiment, the pressurizable fluid reservoir is in intermittent fluid communication with a building water supply. The building water supply can, but need not, both supply diluent for reservoir fluid and supply pressure to pressurize the pressurizable fluid reservoir. Connection to a building water supply may include a mixing valve for mixing the reservoir fluid with a portion of the building water supply.

In a further preferred embodiment, the system may, in the plurality of spray heads, further include a plurality of spray patterns. Various spray patterns can be created to maximize or minimize spray distance, regulate spray coverage, spray around structure corners, or to fulfill virtually any other spray coverage requirement that one skilled in the art may have. In an additional embodiment, the system may include separate but parallel circuits such that the system can accommodate more than one fluid simultaneously.

In certain embodiments, the spray envelopment system may further include at least one auxiliary pressure regulating device in fluid communication with the fluid conduit. Such an auxiliary pressure regulating device might be required, by way of example only, to boost or otherwise regulate pressure in the fluid conduit in certain parts of the system.

In further embodiments of the spray envelopment system, the at least one pressurizable fluid reservoir and the fluid controller may be freestanding from the structure.

In other embodiments, the plurality of spray heads may provide spray coverage to at least a portion, or in some embodiments a majority, of a surface area of at least one of the plurality of external surfaces which may be a depth axis, a height axis, or a width axis of the structure. In still another embodiment of the spray envelopment system, the array may extend along at least two axes selected from the group consisting of a height axis, a width axis, and a depth axis of a structure having a plurality of external surfaces.

In another embodiment of the spray envelopment system, at least a portion of the array is buried underground. This makes the system less aesthetically noticeable, and, when the spray envelopment system utilizes an insecticide as the reservoir fluid, having at least a portion of the array buried underground makes it possible to treat at least a portion of the ground surrounding the structure where insects may dwell, as well as the plurality of external surfaces.

Numerous variations, modifications, alternatives, and alterations of the various preferred embodiments, processes, and methods may be used alone or in combination with one another as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures, all shown not-to-scale:

FIG. 1 shows an elevated perspective view of an embodiment of the instant invention;

FIG. 2 shows an elevation view of an embodiment of the instant invention;

FIG. 3 shows an elevation view of an embodiment of the instant invention;

FIG. 4 shows an elevation view of an embodiment of the instant invention;

FIG. 5 shows an elevation detail of the embodiment of FIG. 1;

FIG. 6 shows an elevation detail of another embodiment of the invention of FIG. 1;

FIG. 7 shows a schematic detail of another embodiment of the invention of FIG. 1;

FIG. 8 shows an embodiment including a second fluid and a second spray array;

FIG. 9 shows details of the embodiment of FIG. 8;

FIG. 10 shows an elevated perspective view of an embodiment of the instant invention;

FIG. 11 shows an elevation view of an embodiment of the instant invention;

FIG. 12 shows an elevation view of an embodiment of the instant invention;

FIG. 13 shows an elevated perspective view of an embodiment of the instant invention;

FIG. 14 shows an elevated perspective view of an embodiment of the instant invention; and

FIG. 15 shows an elevated perspective view of an embodiment of the instant invention.

These drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The spray envelopment system (10) of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the present embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

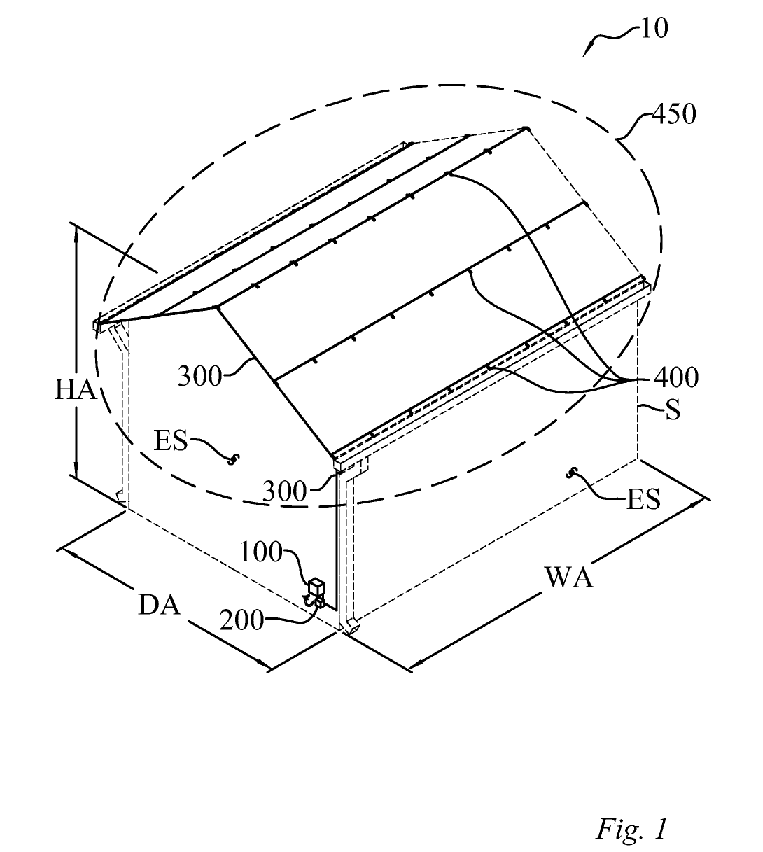

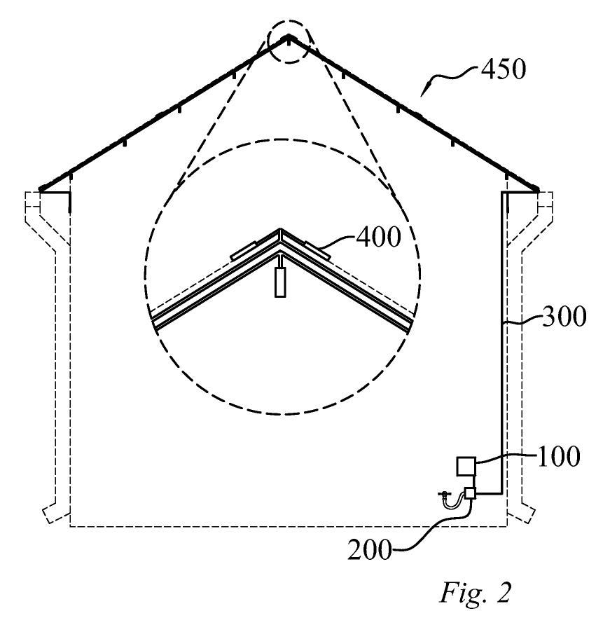

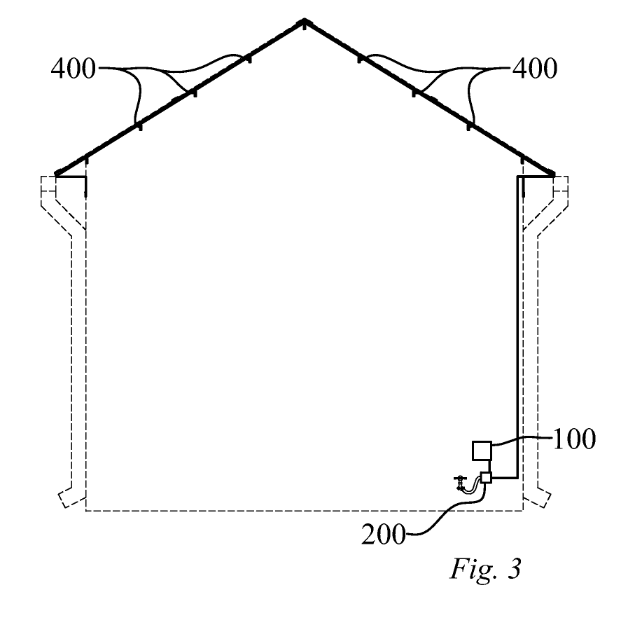

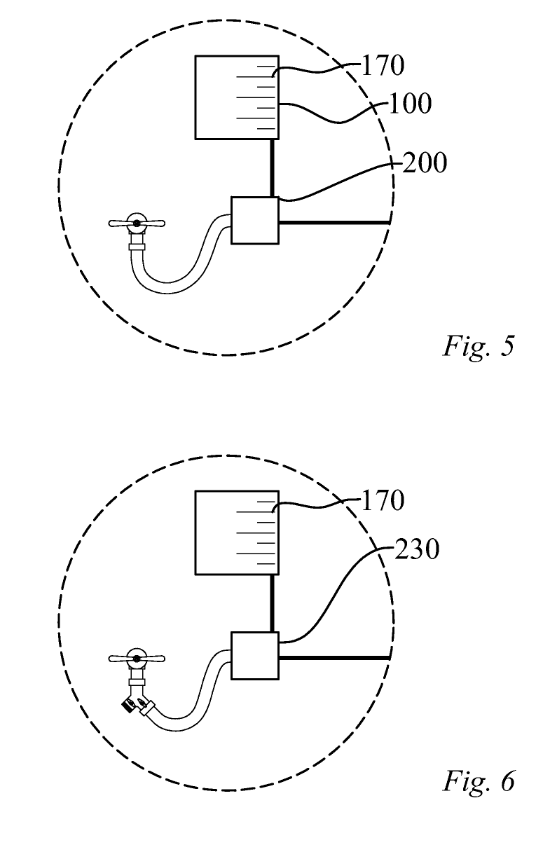

With regards to FIGS. 1-15, a spray envelopment system (10) generally includes at least one pressurizable fluid reservoir (100) containing a reservoir fluid (120), which while, in a preferred embodiment, may be an anti-mold or anti-fungal agent, may also be any fluid with which it might be desired to spray a structure (S). Such fluid may, for purposes of example only and not limitation, include a wide array of anti-mildew agents, preservatives, insecticides, or even water for cooling purposes. As seen in FIGS. 1-4, the pressurizable fluid reservoir (100) is in intermittent fluid communication with at least one fluid conduit (300) and with a fluid controller (200), which controls the intermittent fluid communication of the at least one pressurizable fluid reservoir (100) and the at least one fluid conduit (300). The pressurizable fluid reservoir (100) may include visible indicia (170), seen in FIG. 5, indicating a fill level of the pressurizable fluid reservoir (100), so that a user may visually ascertain the fill level of the fluid reservoir (100) and may know when additional reservoir fluid (120) may be needed.

In an alternate embodiment, the pressurizable fluid reservoir (100) may further include a remotely sensed internet accessible fill level monitor (180). Such a remotely sensed internet accessible fill level monitor (180) could, among other functions, be configured to alert a distant user or a supplier as to the need for additional reservoir fluid (120).

Pressure may be generated within the pressurizable fluid reservoir (100) in the form of a positive pressure created by a pump, fluid ingress, or other force, or may be created as a negative pressure by the withdrawal of contents from the pressurizable fluid reservoir (100).

The fluid controller (200) may have many aspects. In its simplest embodiment, by way of example only and not limitation, it may be a hand controlled valve; or in more complex embodiments, may include a wide variety of automatically controlled and monitored valve systems.

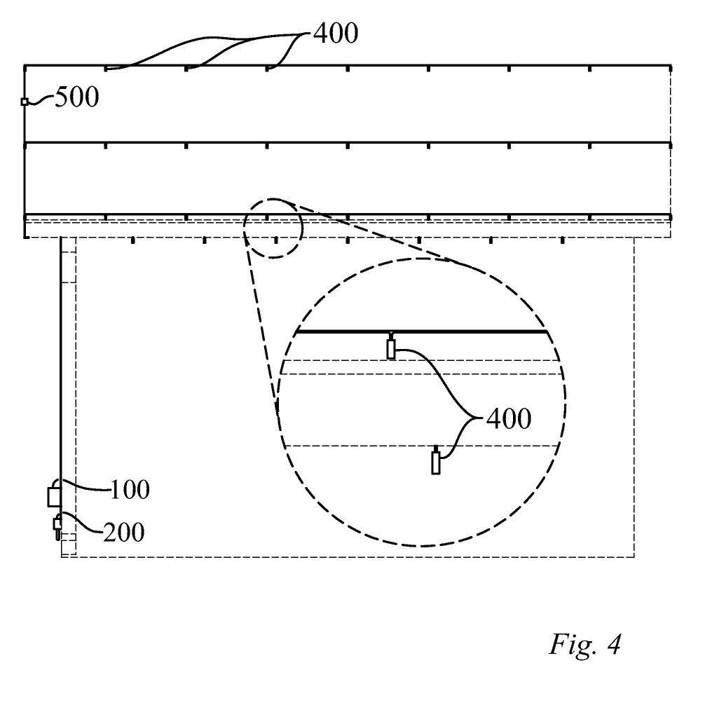

As seen well in FIGS. 1 and 4, the spray envelopment system (10) also includes a plurality of spray heads (400) having at least one spray pattern, in fluid communication with the at least one fluid conduit (300). With reference particularly to FIG. 1, the spray heads (400) and the at least one fluid conduit (300) may further form an array (450) extending along at least a height axis (HA), a width axis (WA), and a depth axis (DA) of a structure (S) having a plurality of external surfaces (ES). As a practical matter, while the spray heads (400) may be placed on any aspect of a structure (S), one skilled in the art will be able to create a pattern for the array (450) to maximize efficiency in spraying the external surfaces (ES) of the structure (S). The plurality of spray heads (400), when in fluid communication with the pressurizable fluid reservoir (100), provide simultaneous spray coverage to at least a portion, or in some embodiments a majority, of a surface area of the plurality of external surfaces (ES) of a structure (S).

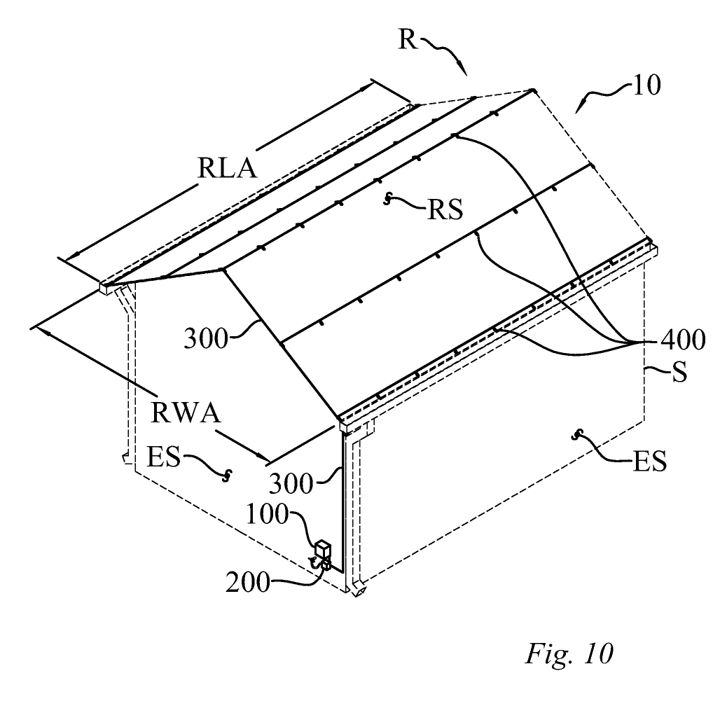

While it may be desirable to extend spray coverage over only a part or all of the external surfaces (ES) of a structure (S), it may be desired to include a roof (R) of any such structure (S) in coverage. In one embodiment, seen well in FIG. 10, the spray envelopment system (10) may be configured for coverage of a roof (R) as well as for other structure external surfaces (ES). In such an embodiment, seen well in FIG. 10, the plurality of external surfaces (ES) includes a roof surface (RS), and the array (450) extends in at least a roof length axis (RLA) and a roof width axis (RWA). The plurality of spray heads (400), when in fluid communication with the pressurizable fluid reservoir (100), provides a simultaneous spray coverage to at least a portion of the roof surface (RS). Again, one skilled in the art could design placement of the spray heads (400) for maximum efficiency, but in particular, as seen well in FIGS. 1-4 and 10, it may be advantageous to place spray heads along a roof line, along roof gable ends, and along roof gutters.

In different embodiments, the fluid controller (200) may further include a timer (230), seen in FIG. 6; and/or the fluid controller (200) may further include a remotely operable internet accessible controller (240). The latter could allow long-distance control of the system (10); and any of the previously discussed embodiments may be configured for regular and periodic activation of system, in at least some embodiments, without direct manual activation.

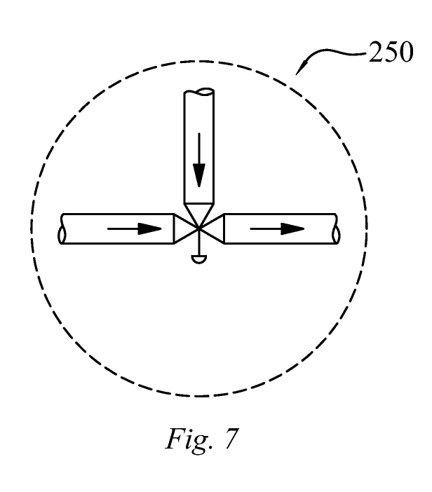

In a preferred embodiment, the pressurizable fluid reservoir (100) is in intermittent fluid communication with a building water supply, seen well in FIGS. 5 and 6. The building water supply can, but need not, both supply diluent for reservoir fluid (120) and supply pressure to pressurize the pressurizable fluid reservoir (100). One skilled in the art will realize that connection to a building water supply may include a mixing valve (250) for mixing the reservoir fluid (120) with a portion of the building water supply. Such a valve can be configured in a variety of manual and/or automatic designs, and is shown schematically only in FIG. 7, where two inflow conduits may be seen mixing contents to form one outflow stream. Among the many variations that would be known to one skilled in the art, connection to the building water supply may be by hard piping; by hose run from an existing hose bib, as seen in FIG. 5; or by hose run from an existing hose bib equipped with a y-type valve, as seen in FIG. 6; so that the hose bib might be used independently of the system (10).

In a further preferred embodiment, the system (10) may, in the plurality of spray heads (400), further include a plurality of spray patterns. By way of example and not limitation, various spray patterns can be created to maximize or minimize spray distance, regulate spray coverage, spray around structure corners, or to fulfill virtually any other spray coverage requirement that one skilled in the art may have.

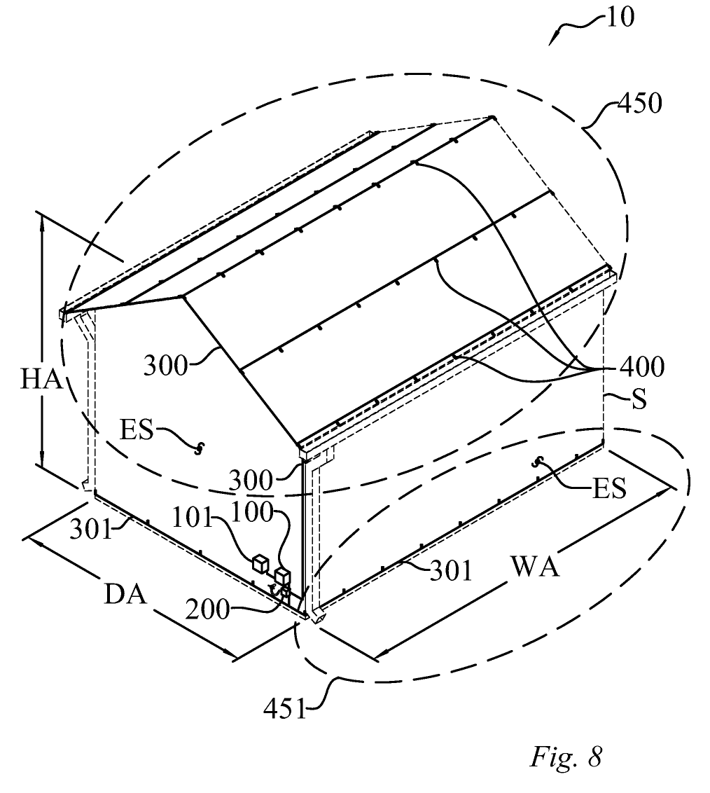

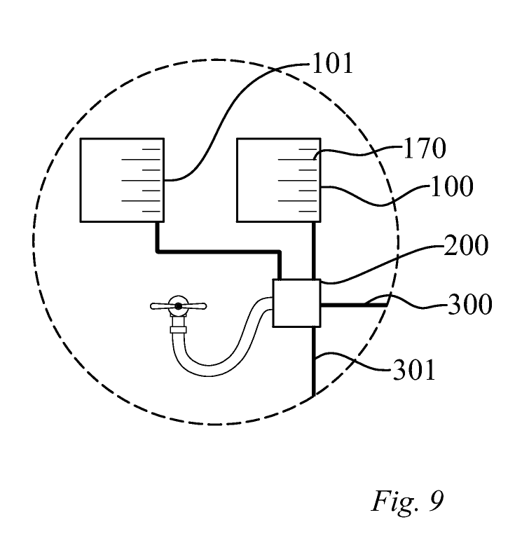

One skilled in the art will appreciate that the system (10) could also include separate but parallel circuits such that the overall system (100) is able to utilize more than a single reservoir fluid (120) at the same time. As seen in FIGS. 8-9, by way of example only, a second array (451) may be placed alongside a lower wall area of the external surfaces (ES) of the structure (S). Such a second array (451) may be connected, via a second fluid conduit (301) to a second pressurizable fluid reservoir (101), that is separate from the first pressurizable fluid reservoir (100), and which contains a second reservoir fluid (121) from that supplying other portions of the system (10). Thus, by way of example only, it would be possible for the system (10) to spray an anti-mold agent on a portion of the external surfaces (ES) of the structure (S), while also spraying an insecticide along the lower wall edges of the external surfaces (ES) of the structure (S).

In detail, such a separate but parallel circuit system (10) could thereby include at least a first pressurizable fluid reservoir (100), containing a first reservoir fluid (120), in intermittent fluid communication with a first fluid conduit (300). Additionally, at least a second pressurizable fluid reservoir (101) containing a second reservoir fluid (121) could be in intermittent fluid communication with a second fluid conduit (301).

At least one fluid controller (200) could control the intermittent fluid communication of the first pressurizable fluid reservoir (100) and the first fluid conduit (300), and could control the intermittent fluid communication of the second pressurizable fluid reservoir (101) and the second fluid conduit (301); although one skilled in the art would realize that multiple fluid controllers (200) could be employed.

Such a system could include a plurality of spray heads (400) having at least one spray pattern in fluid communication with the first fluid conduit (300) and the second fluid conduit (301) wherein the spray heads (400) and the first fluid conduit (300) and second fluid conduit (301) could further include a first array (450) and a second array (451).

A first array (450) could extend along at least a height axis (HA), a width axis (WA), and a depth axis (DA) of a structure (S) having a plurality of external surfaces (ES), wherein the plurality of spray heads (400), when in fluid communication with the first pressurizable fluid reservoir (100), provide simultaneous spray coverage of a first reservoir fluid (120) to a surface area of the plurality of external surfaces (ES).

Similarly, a second array (451) could extend along at least an axis selected from the group of axes consisting of a width axis (WA) and a depth axis (DA) of a structure (S) wherein the plurality of spray heads (400), when in fluid communication with the second pressurizable fluid reservoir (101), provide simultaneous spray coverage of a second reservoir fluid (121) to a surface area of the plurality of external surfaces (ES).

In certain embodiments, the spray envelopment system (10) may further include at least one auxiliary pressure regulating device (500) in fluid communication with the fluid conduit (300), as seen well in FIG. 4. Such an auxiliary pressure regulating device (500) might be required, by way of example only, to boost or otherwise regulate pressure in the fluid conduit (300) in certain parts of the system (10).

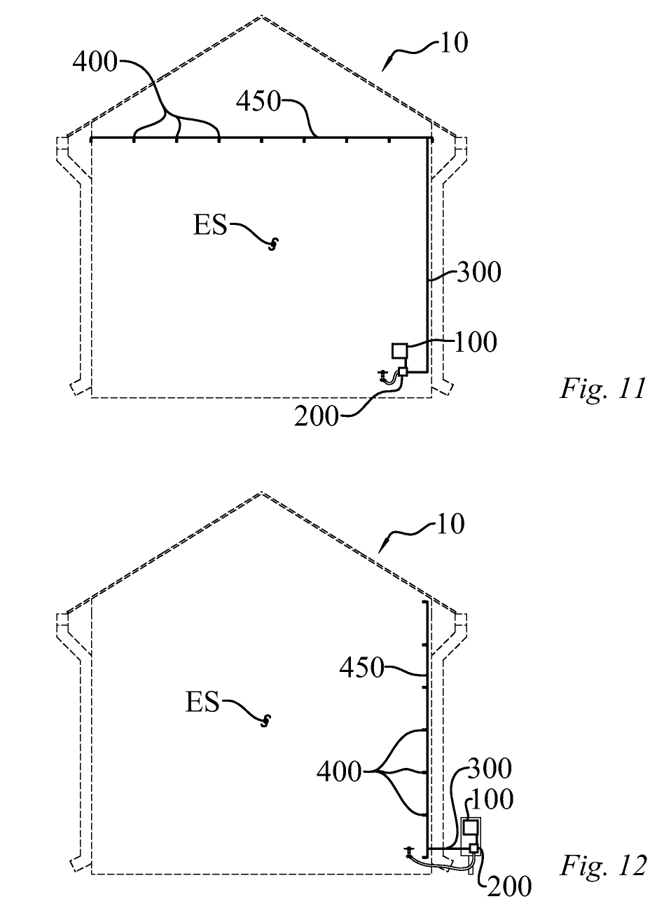

Turning now to FIG. 11, an additional embodiment of the spray envelopment system (10) is shown. As seen in FIG. 11, the spray envelopment system (10) includes at least one pressurizable fluid reservoir (100) containing a reservoir fluid (120). The at least one pressurizable fluid reservoir (100) is in intermittent fluid communication with at least one fluid conduit (300) and with a fluid controller (200), which controls the intermittent fluid communication of the at least one pressurizable fluid reservoir (100) and the at least one fluid conduit (300). As seen in FIG. 12, the at least one pressurizable fluid reservoir (100) and the fluid controller (200) may be freestanding from the structure (S).

In a particular embodiment, the spray envelopment system (10) includes a plurality of spray heads (400) having at least one spray pattern, in fluid communication with the at least one fluid conduit (300). The plurality of spray heads (400) and the at least one fluid conduit (300) further form an array (450) extending along at least one of a height axis (HA), a width axis (WA), and a depth axis (DA) of a structure (S) having a plurality of external surfaces (ES). Thus, when the plurality of spray heads (400) are in fluid communication with the at least one pressurizable fluid reservoir (100), the plurality of spray heads (400) provides a spray coverage to at least a portion, or in some embodiments a majority, of a surface area of at least one of the plurality of external surfaces (ES).

Still referring to FIG. 11, the array (450) extends only along the depth axis (DA) of the structure (S). However, as seen in FIG. 12, the array (450) may extend only along the height axis (HA) of the structure (S), or the array (450) may extend only along the width axis (WA) of the structure (S). Thus, the plurality of spray heads (400) may provide a spray coverage to at least a portion, or in some embodiments a majority, of the surface area of at least one of the external surface (ES).

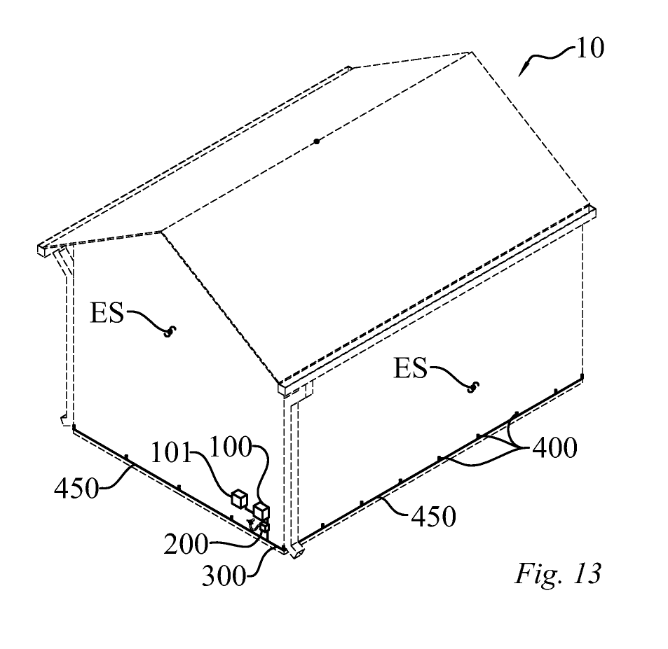

In still another embodiment of the spray envelopment system (10), the array (450) may extend along at least two axes selected from the group consisting of a height axis (HA), a width axis (WA), and a depth axis (DA) of a structure (S) having a plurality of external surfaces (ES), as seen in FIG. 13. In this particular embodiment, when the plurality of spray heads (400) are in fluid communication with the at least one pressurizable fluid reservoir (100), the plurality of spray heads (400) provides a simultaneous spray coverage to at least a portion, or in some embodiments a majority, of a surface area of at least two of the plurality of external surfaces (ES).

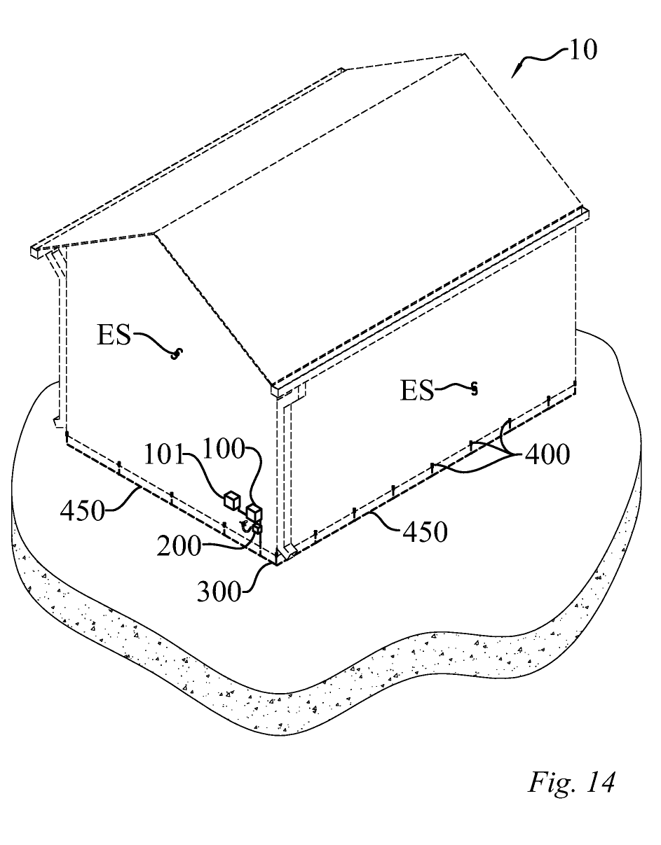

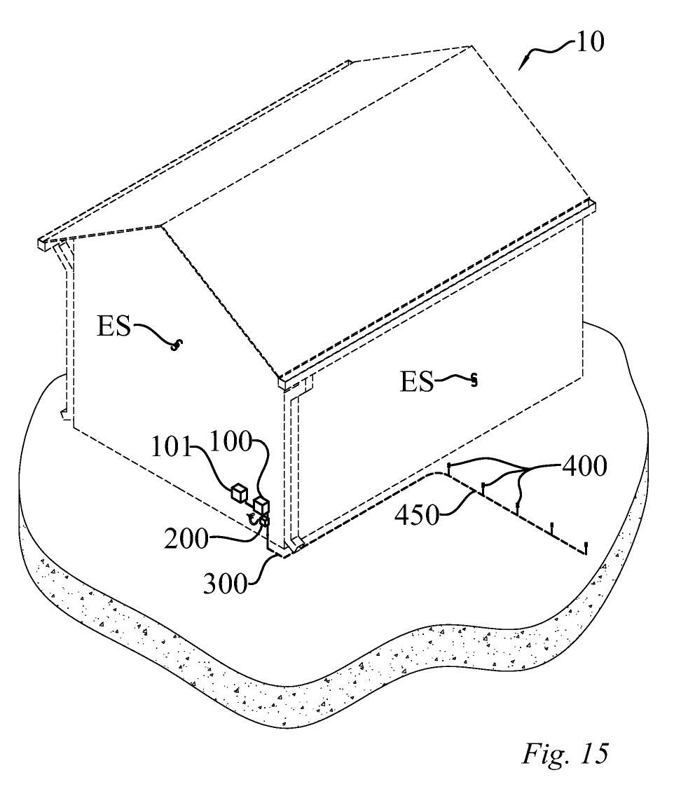

Referring now to FIGS. 14 and 15, an additional embodiment of the spray envelopment system (10) is shown. In this particular embodiment, at least a portion of the array (450) is buried underground. By burying a portion of the array (450) underground, the spray envelopment system (10) is less noticeable, which improves the aesthetics of the system (10). Additionally, when the spray envelopment system (10) utilizes an insecticide as the reservoir fluid (120), having at least a portion of the array (450) buried underground makes it possible to treat at least a portion of the ground surrounding the structure (S) where insects may dwell, as well as the plurality of external surfaces (ES).

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A spray envelopment system (10) comprising;
at least one pressurizable fluid reservoir (100) containing a reservoir fluid (120) in intermittent fluid communication with at least one fluid conduit (300);
a fluid controller (200) for controlling the intermittent fluid communication of the at least one pressurizable fluid reservoir (100) and the at least one fluid conduit (300);
a plurality of spray heads (400) having at least one spray pattern in fluid communication with the at least one fluid conduit (300), wherein the plurality of spray heads (400) and the at least one fluid conduit (300) further comprise,
an array (450) extending along at least one of a height axis (HA), a width axis (WA), and a depth axis (DA) of a structure (S) having a plurality of external surfaces (ES), wherein the plurality of spray heads (400), when in fluid communication with the at least one pressurizable fluid reservoir (100), provides a spray coverage to at least a portion of a surface area of at least one of the plurality of external surfaces (ES).

2. The system of claim 1, wherein the plurality of external surfaces (ES) includes a roof surface (RS), and the array (450) extends in at least a roof length axis (RLA) and a roof width axis (RWA), wherein the plurality of spray heads (400), when in fluid communication with the at least one pressurizable fluid reservoir (100), provides a simultaneous spray coverage to at least a portion of the roof surface (RS).

3. The system of claim 1, wherein the fluid controller (200) further comprises a timer (230).

4. The system of claim 1, wherein the fluid controller (200) further comprises a remotely operable internet accessible controller (240).

5. The system of claim 1, wherein the pressurizable fluid reservoir (100) is in intermittent fluid communication with a building water supply.

6. The system of claim 1, wherein the plurality of spray heads (400) further comprises a plurality of spray patterns.

7. The system of claim 1, further comprising at least one auxiliary pressure regulating device (500) in fluid communication with the fluid conduit (300).

8. The system of claim 5, wherein the fluid controller (200) further comprises a mixing valve (250) for mixing the pressurizable fluid reservoir fluid (120) with a portion of the building water supply.

9. The system of claim 1, wherein the pressurizable fluid reservoir (100) further comprises visible indicia (170) indicating a fill level of the pressurizable fluid reservoir (100).

10. The system of claim 1, wherein the pressurizable fluid reservoir (100) further comprises a remotely sensed internet accessible fill level monitor (180).

11. The system of claim 1, wherein the pressurizable reservoir fluid (120) further comprises an anti-mold agent.

12. A spray envelopment system (10) comprising;
at least one pressurizable fluid reservoir (100) containing a reservoir fluid (120) in intermittent fluid communication with at least one fluid conduit (300);
a fluid controller (200) for controlling the intermittent fluid communication of the at least one pressurizable fluid reservoir (100) and the at least one fluid conduit (300);
a plurality of spray heads (400) having a plurality of spray patterns, in fluid communication with the at least one fluid conduit (300), wherein the plurality of spray heads (400) and the at least one fluid conduit (300) further comprise,
an array (450) extending along at least two of a height axis (HA), a width axis (WA), and a depth (DA) axis of a structure (S) having a plurality of external surfaces (ES), wherein the plurality of spray heads (400), when in fluid communication with the at least one pressurizable fluid reservoir (100), provides a simultaneous spray coverage to at least a portion of a surface area of at least two of the plurality of external surfaces (ES).

13. The system of claim 12, wherein the fluid controller (200) further comprises a timer (230).

14. The system of claim 12, wherein the fluid controller (200) further comprises a remotely operable internet accessible controller (240).

15. The system of claim 12, wherein the pressurizable fluid reservoir (100) is in intermittent fluid communication with a building water supply.

16. A spray envelopment system (10) comprising;
at least one pressurizable fluid reservoir (100) containing a reservoir fluid (120) in intermittent fluid communication with at least one fluid conduit (300);
a fluid controller (200) for controlling the intermittent fluid communication of the at least one pressurizable fluid reservoir (100) and the at least one fluid conduit (300);
a plurality of spray heads (400) having at least one spray pattern in fluid communication with the at least one fluid conduit (300), wherein the plurality of spray heads (400) and the at least one fluid conduit (300) further comprise,
an array (450) extending along at least one of a height axis (HA), a width axis (WA), and a depth axis (DA) of a structure (S) having a plurality of external surfaces (ES, wherein at least a portion of the array (450) is buried underground, and wherein the plurality of spray heads (400), when in fluid communication with the pressurizable fluid reservoir (100), provides a spray coverage to at least a portion of a surface area of at least one of the plurality of external surfaces (ES).

17. The system of claim 16, wherein the fluid controller (200) further comprises a timer (230).

18. The system of claim 16, wherein the fluid controller (200) further comprises a remotely operable internet accessible controller (240).

19. The system of claim 16, further comprising at least one auxiliary pressure regulating device (500) in fluid communication with the fluid conduit (300).

20. The system of claim 16, wherein pressurizable fluid reservoir (100) further comprises a remotely sensed internet accessible fill level monitor (180).
